(19) United States
(12) Patent Application Publication
(10) Pub. No.: US 2016/0341880 A1
(43) Pub. Date: Nov. 24, 2016

(54) Light guiding plate and display module

(71) Applicant: Shenzhen China Star Optoelectronics Technology Co., Ltd., Shenzhen, Guangdong (CN)

(72) Inventor: Yanxue ZHANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/428,362

(22) PCT Filed: Jan. 20, 2015
(86) PCT No.: PCT/CN2015/071135

§ 371 Date: Mar. 14, 2015

(30) Foreign Application Priority Data
Dec. 31, 2014 (CN) 201410854019.2

(51) Int. Cl. F21V 8/00

(52) U.S. Cl. CPC G02B 6/0046; G02B 6/0043

(57) ABSTRACT

The embodiment of the disclosure provides a light guiding plate comprising two light input surfaces at the two lateral sides, a light output surface at the top side and a scattering surface at the bottom side, scattering nodes are disposed on the scattering surface, and the scattering surface concaves toward the light output surface. The embodiment of the disclosure further provides a display module, comprising a display panel a backlight unit. The backlight unit comprises the light guiding plate, and LED modules disposed at the two opposite sides of the light guiding plate. The backlight of the light guiding plate is more uniform and the backlight effect is improved because light can enter the structure at the two sides as well as the scattering surface of the bottom side concaves toward the light output surface.

### BACKGROUND OF THE INVENTION

1. Field of the Invention

The disclosure relates to the backlight display field, and more particularly, to a light guiding plate and a display module.

2. The Related Arts

As the development of the electronic devices, it is more and more important to improve the uniformity of the backlight of display devices. At present, light guiding plates are designed as a plate-like structure, and nodes, which are beneficial to scattering light, are disposed at the bottom of the light guiding plate so as to reflect light. However, this structure fails to significantly improve the uniformity of light.

### SUMMARY

According to the above problems, the disclosure provides a light guiding plate and a display module with better uniformity.

In order to accomplish the above purpose, the disclosure provides the followings:

a light guiding plate, comprising two light input surfaces at the two lateral sides, a light output surface at the top side and a scattering surface at the bottom side, scattering nodes are disposed on the scattering surface, and the scattering surface concaves toward the light output surface.

In one embodiment, the scattering surface is composed of the inclined surfaces of the bottom ends of the light input surfaces at the two lateral sides inclining toward the light output surface.

In one embodiment, the two inclined surfaces are intersected at the middle part of the scattering surface.

In one embodiment, the scattering surface is a cambered surface.

In one embodiment, the scattering surface is coated by reflective materials.

At meanwhile, the disclosure provides also provides a display module, comprising a display panel and a backlight unit, the backlight unit comprising the light guiding plate described above and LED modules disposed at the two opposite sides of the light guiding plate.

In one embodiment, the backlight unit comprises a reflective layer and a back plate disposed under the scattering surface in sequence.

In one embodiment, the reflective layer is the reflective materials coated on the scattering surface.

In one embodiment, the reflective layer is a reflective plate attaching to the scattering surface.

In one embodiment, the middle of the back plate is convex toward and attach to the bottom surface of the reflective layer.

According to the disclosure, light can enter the light guiding plate from the two sides. Also, the scattering surface of the bottom side concaves toward the light output surface, so that the backlight of the light guiding plate is more uniform and the backlight effect is improved.

### BRIEF DESCRIPTION OF THE DRAWINGS

In order to explain the technical solutions of the disclosure more clearly, the brief description of the drawings for explanation of the embodiments is given as below. Apparently, the following drawings are merely some embodiments of the disclosure. For those skilled in the art, the other drawings are attainable without creative endeavor according to these drawings, wherein:

FIG. 1 is the schematic diagram of a light guiding plate of Embodiment 1 according to the disclosure;

FIG. 2 is the schematic diagram of another light guiding plate of Embodiment 1 according to the disclosure;

FIG. 3 is the schematic diagram of a display module of Embodiment 1 according to the disclosure;

FIG. 4 is the schematic diagram of a display module of Embodiment 2 according to the disclosure;

FIG. 5 is the schematic diagram of a display module of Embodiment 3 according to the disclosure; and

FIG. 6 is the schematic diagram of a display module of Embodiment 4 according to the disclosure.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

### Embodiment 1

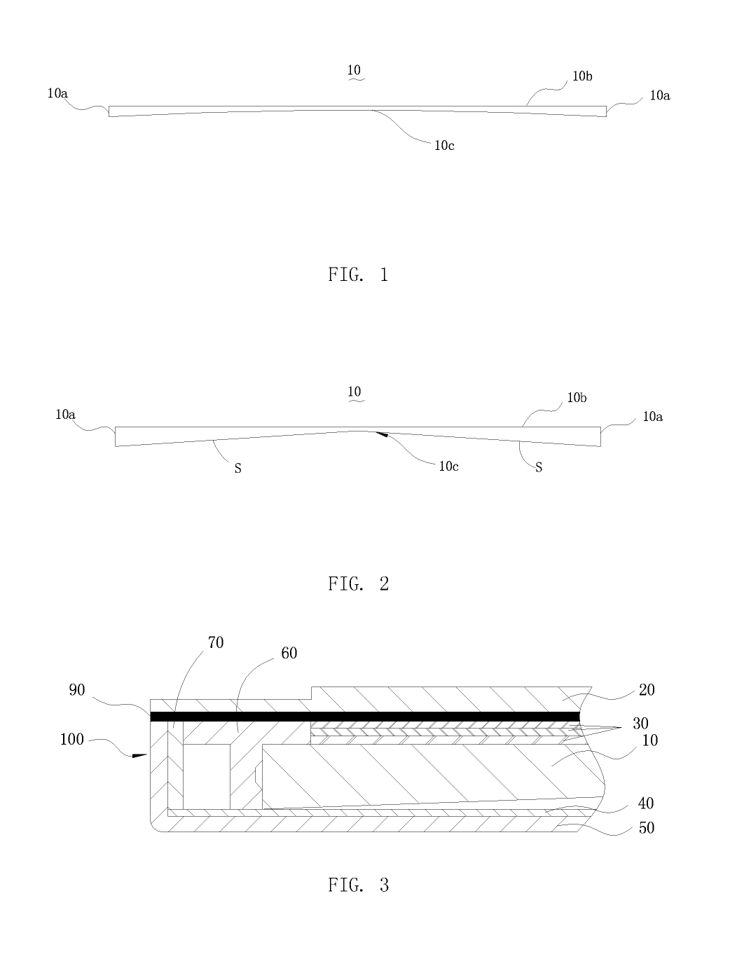

Refer to FIGS. 1-2, the light guiding plate 10 of the embodiment comprises two light input surfaces 10a at the two lateral sides, a light output surface 10b at the top side and a scattering surface 10c at the bottom side, wherein scattering nodes are disposed on the scattering surface 10c, and the scattering surface 10c concaves toward the light output surface 10b.

Since the scattering surface 10c concaves toward the light output surface 10b, the light entering from the two sides of the light input surface 10a is able to enter the scattering surface 10c in a shorter light path, and the light is radiated toward the environment. As a result, the light leaving the light output surface 10 b is more uniform.

Specifically, the scattering surface 10c is a cambered surface (as shown in FIG. 1). Alternatively, the scattering surface 10c is composed of the inclined surfaces S of the bottom ends of the light input surfaces 10a at the two lateral sides. The inclined surfaces S incline toward the light output surface 10b. In this embodiment, the two inclined surfaces S are, preferably, intersected at the middle part of the scattering surface.

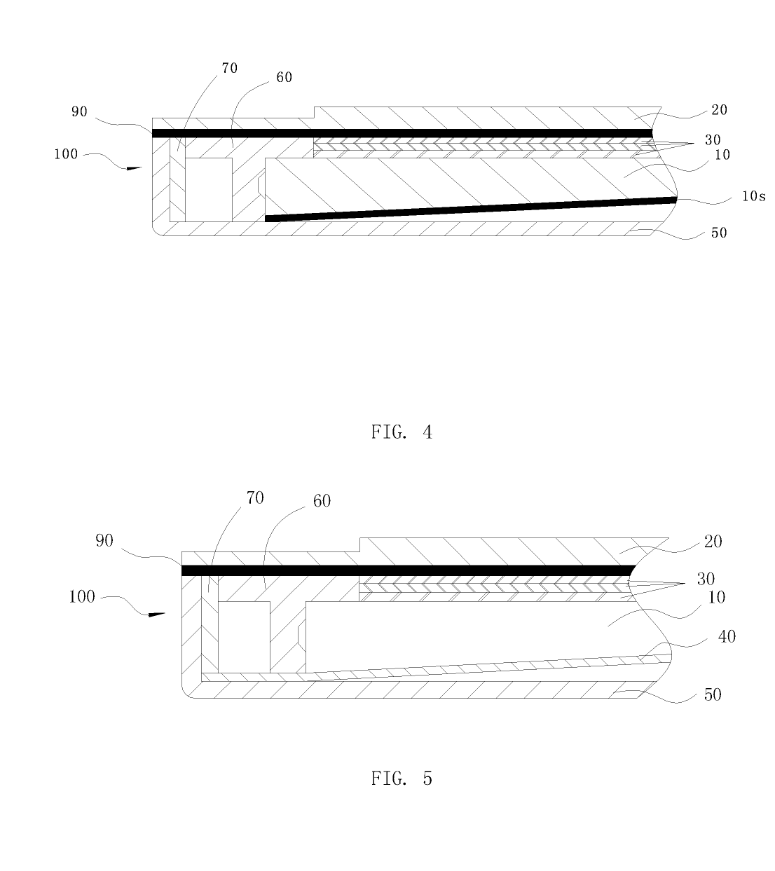

Refer to FIG. 3, light can enter the light guiding plate from the two sides. The display module comprises a display panel 20 and a backlight unit 100. The backlight unit 100 comprises a light guiding plate 10, LED modules 60, a reflective layer 40 and a metal of back plate 50. The LED modules 60 are disposed at the two opposite sides of the light guiding plate 10. The reflective layer 40 and the back plate 50 are disposed under the scattering later 10c. The reflective layer 40 attaches the top surface of the back plate 50, so as to reflect the light transmitting the light guiding plate 10 and entering the reflective layer 40, and thus the usage of the light is improved.

Moreover, the backlight unit 100 can further comprise a plastic frame 70 so as to protect the LED modules 60 and the light guiding plate 10. The display panel 20 is adhesive on the top surface of the backlight unit 100 through an adhesive layer 90.

### Embodiment 2

As shown in FIG. 4, the difference between Embodiment 2 and Embodiment 1 is that the scattering surface 10c in the embodiment is coated by reflective materials. The layer of reflective materials 10s is the reflective layer 40 of the backlight unit 100 for reflecting the light entering the scattering surface 10c from the LED modules 60 at disposed at the two opposite sides.

### Embodiment 3

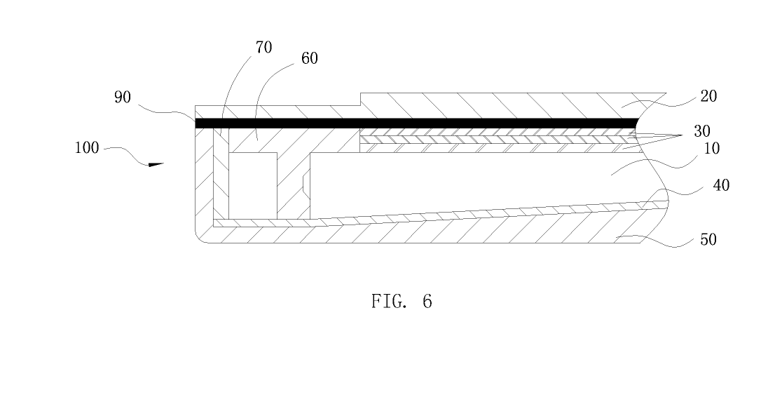

As shown in FIG. 5, the difference between Embodiment 3 and Embodiment 1 is that the reflective layer 40 in the embodiment is a layer of reflective plate, and the reflective plate attaches the scattering surface 10c.

### Embodiment 4

As shown in FIG. 6, based on Embodiments 1˜3, the middle of the back plate 50 is convex toward and attach to the bottom surface of the reflective layer 40 so as to support the scattering surface 10c, which concaves. As compared with the above embodiments, the display module is more compact and has a greater strength.

Although the present disclosure is illustrated and described with reference to specific embodiments, those skilled in the art will understand that many variations and modifications are readily attainable without departing from the spirit and scope. Such variations and modifications should also be regarded as the protection of the disclosure.

What is claimed is:

1. A light guiding plate, comprising two light input surfaces at the two lateral sides, a light output surface at the top side and a scattering surface at the bottom side, scattering nodes are disposed on the scattering surface, and the scattering surface concaves toward the light output surface.

2. The light guiding plate according to claim 1, wherein the scattering surface is composed of the inclined surfaces of the bottom ends of the light input surfaces at the two lateral sides inclining toward the light output surface.

3. The light guiding plate according to claim 2, wherein the two inclined surfaces is intersected at the middle part of the scattering surface.

4. The light guiding plate according to claim 1, wherein the scattering surface is a cambered surface.

5. The light guiding plate according to claim 1, wherein the scattering surface is coated by reflective materials.

6. The light guiding plate according to claim 2, wherein the scattering surface is coated by reflective materials.

7. The light guiding plate according to claim 4, wherein the scattering surface is coated by reflective materials.

8. A display module, comprising a display panel and a backlight unit, the backlight unit comprising a light guiding plate, and LED modules disposed at the two opposite sides of the light guiding plate, the light guiding plate comprising two light input surfaces at the two lateral sides, a light output surface at the top side and a scattering surface at the bottom side, scattering nodes are disposed on the scattering surface, and the scattering surface concaves toward the light output surface.

9. The display module according to claim 8, wherein the backlight unit comprises a reflective layer and a back plate disposed under the scattering surface in sequence.

10. The display module according to claim 9, wherein the middle of the back plate is convex toward and attaches to the bottom surface of the reflective layer.

11. The display module according to claim 8, wherein the reflective layer is the reflective materials coated on the scattering surface.

12. The display module according to claim 11, wherein the middle of the back plate is convex toward and attaches to the bottom surface of the reflective layer.

13. The display module according to claim 9, wherein the reflective layer is a reflective plate attaching to the scattering surface.

14. The display module according to claim 13, wherein the middle of the back plate is convex toward and attaches to the bottom surface of the reflective layer.

15. The display module according to claim 8, wherein the scattering surface is composed of the inclined surfaces of the bottom ends of the light input surfaces at the two lateral sides inclining toward the light output surface.

16. The display module according to claim 8, wherein the scattering surface is a cambered surface.

17. The display module according to claim 16, wherein the backlight unit comprises a reflective layer and a back plate disposed under the scattering surface in sequence.

18. The display module according to claim 17, wherein the reflective layer is the reflective materials coated on the scattering surface.

19. The display module according to claim 18, wherein the reflective layer is a reflective plate attaching to the scattering surface.

20. The display module according to claim 19, wherein the middle of the back plate is convex toward and attaches to the bottom surface of the reflective layer.
